(19) United States
(12) Patent Application Publication
(10) Pub. No.: US 2026/0362021 A1
(43) Pub. Date: Nov. 12, 2026

(54) NOISE PROFILE GENERATION METHOD, NOISE PROFILE GENERATION SYSTEM AND IMAGE NOISE REDUCTION METHOD

(71) Applicant: MEDIATEK INC., Hsinchu City (TW)

(72) Inventor: Chi-De Chen, Hsinchu City (TW)

(73) Assignee: MEDIATEK INC., Hsinchu City (TW)

(21) Appl. No.: 19/204,651

(22) Filed: May 12, 2025

(51) Int. Cl. H04N 23/88; G06T 7/80; G06T 7/90

(52) U.S. Cl. CPC H04N 23/88; G06T 7/80; G06T 7/90; G06T 2207/10024

(57) ABSTRACT

A noise profile generation method, for generating noise profiles of an image recording device, comprising: (a) capturing at least one first test image of at least one test object by using a first color temperature and a brightness condition; (b) computing a first noise profile according to the first test image; (c) capturing at least one second test images of the test object by using a second color temperature different from the first color temperature and the brightness condition; and (d) computing a second noise profile according to the second test image.

### BACKGROUND

The present application relates to a noise profile generation method, a noise profile generation system and an image noise reduction method, and particularly relates to a noise profile generation method, a noise profile generation system and an image noise reduction method which can compensate noises caused by white balance operations.

A camera always comprises an ISP (Image Signal Processor) for processing image data sensed by an image sensor to generate images. The ISP may have a noise reduction function to reduce image noise. Also, the parameter of the ISP may be set according to a noise profile such that the ISP may have a better noise reduction function. The noise profile may comprise, for example, noise levels or distributions of the image noise. However, the image noise may vary corresponding to different conditions of the camera. For example, different combinations of lens and image sensors of the camera may cause different image noise. For another example, different ISO values of the camera may cause different image noise.

Also, under certain circumstances, a white balance operation is performed to the test images which are used for generating the noise profile. A conventional white balance provides at least one white balance gain to adjust some color channels. However, if the white balance gain is high, the noises of the color channels which are adjusted may also be amplified. Accordingly, the test images with different color temperatures may have different image noises caused by different white balance gains. However, the conventional noise reduction function does not consider such issues.

### SUMMARY

One objective of the present application is to provide a noise profile generation method which can select a proper noise profile corresponding to a current CT.

Another objective of the present application is to provide a noise profile generation system which can select a proper noise profile corresponding to a current CT.

Still another objective of the present application is to provide an image noise reduction method which can select a proper noise profile corresponding to a current CT.

One embodiment of the present application discloses a noise profile generation method, for generating noise profiles of an image recording device, comprising: (a) capturing at least one first test image of at least one test object by using a first color temperature and a brightness condition; (b) computing a first noise profile according to the first test image; (c) capturing at least one second test images of the test object by using a second color temperature different from the first color temperature and the brightness condition; and (d) computing a second noise profile according to the second test image.

Another embodiment of the present application discloses a noise profile generation system, comprising: an image recording device; and a processing circuit, configured to execute at least one program stored in a storage device to perform a noise profile generation method, which comprises following steps: (a) capturing at least one first test image of at least one test object by using a first color temperature and a brightness condition; (b) computing a first noise profile according to the first test image; (c) capturing at least one second test images of the test object by using a second color temperature different from the first color temperature and the brightness condition; and (d) computing a second noise profile according to the second test image.

Still another embodiment of the present application discloses an image noise reduction method, for reducing image noise of images generated by the image recording device, comprising: (a) capturing at least one first test image of at least one test object by using a first color temperature and a brightness condition; (b) computing a first noise profile according to the first test image; (c) capturing at least one second test images of the test object by using a second color temperature different from the first color temperature and the brightness condition; (d) computing a second noise profile according to the second test image; and (e) selectively setting parameters of the image recording device according to the first noise profile or the second noise profile corresponding to a current color temperature while calibrating the image recording device.

In one embodiment, the above-mentioned brightness condition comprises an aperture size of the image recording device. In another embodiment, the brightness condition comprises an exposure time of an image sensor of the image recording device. In still another embodiment, the brightness condition comprises a luminance of light received by an image sensor of the image recording device.

In view of above-mentioned embodiments, noise profiles corresponding to different CT may be acquired, and a proper noise profile may be selected corresponding to a current CT, to improve the efficiency of noise reduction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a color checker used in the noise profile generation method according to one embodiment of the present application.

FIG. 2, FIG. 3 and FIG. 4 are schematic diagrams illustrating operations of a noise profile generation method according to different embodiments of the present application.

FIG. 5 is a flow chart illustrating a noise profile generation method according to one embodiment of the present application.

FIG. 6 is a block diagram illustrating a noise profile generation system according to one embodiment of the present application.

FIG. 7 is a block diagram illustrating an exemplary image recording device, which is calibrated according to the noise profile generated by the embodiments of the present application.

### DETAILED DESCRIPTION

Several embodiments are provided in following descriptions to explain the concept of the present invention. The method in following descriptions can be performed by programs stored in a non-transitory computer readable recording medium by a processing circuit. The non-transitory computer readable recording medium can be, for example, a hard disk, an optical disc or a memory. Additionally, the term “first”, “second”, “third” in following descriptions are only for the purpose of distinguishing different one elements, and do not mean the sequence of the elements. For example, a first device and a second device only mean these devices can have the same structure but are different devices. Besides, in following embodiment, a camera is used as an example for explaining, but the camera may be replaced by any other image recording device.

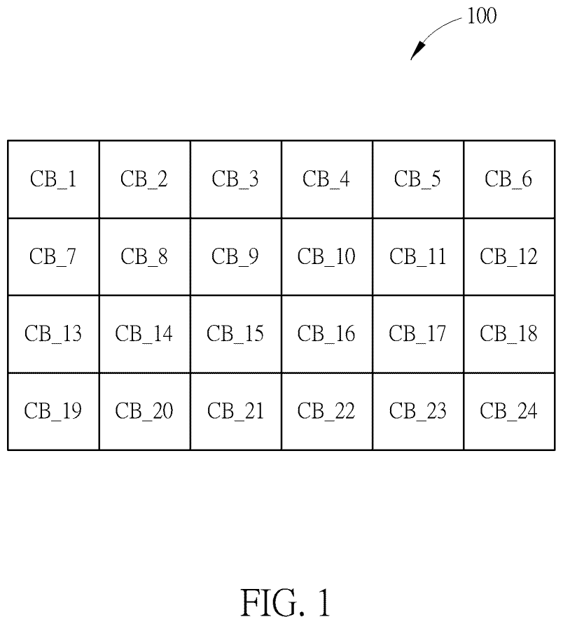

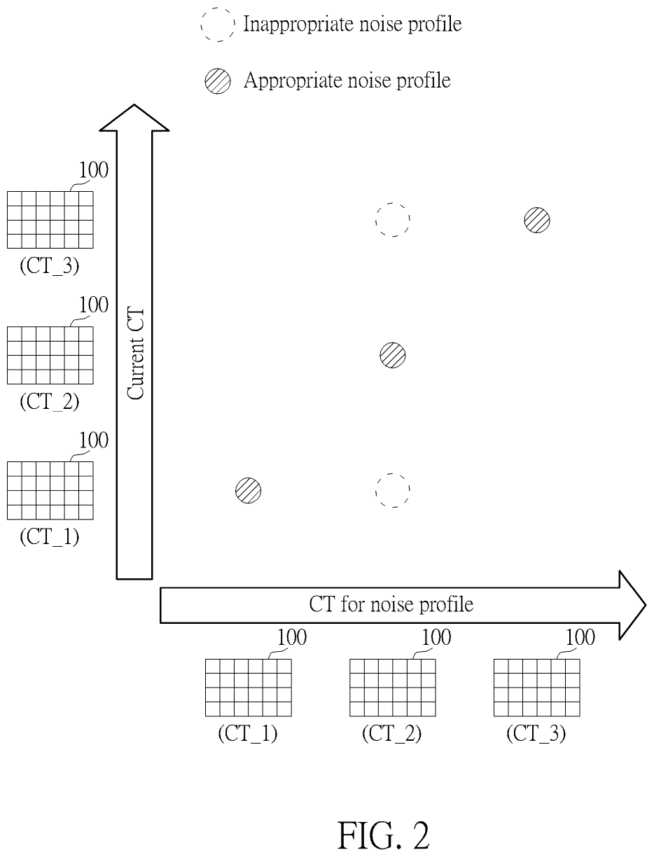

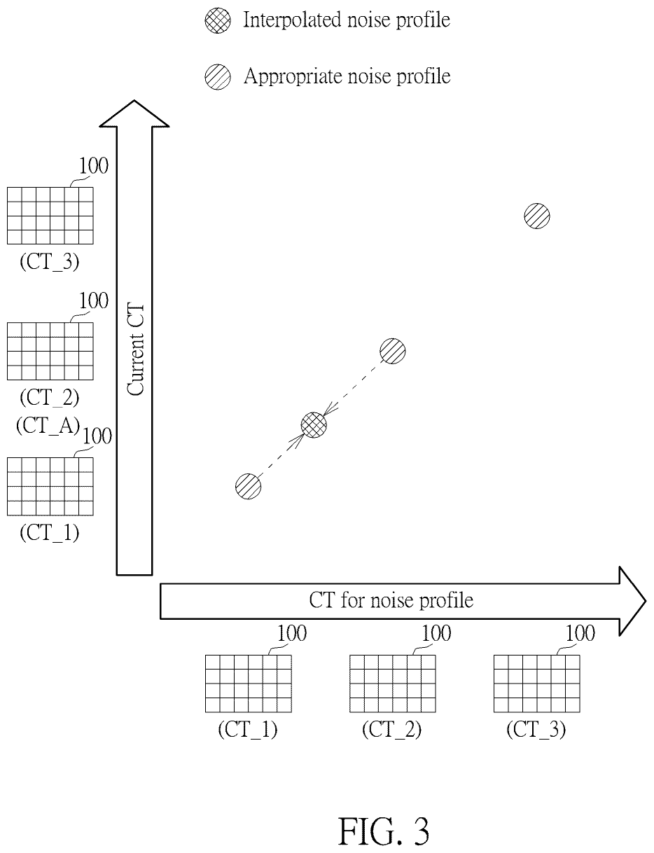

FIG. 1 is a schematic diagram illustrating a color checker used in the noise profile generation method according to one embodiment of the present application. As illustrated in FIG. 1, the color checker 100 have 24 color blocks CB_1 . . . CB_24, which respectively have different colors. Please note, the number of the color blocks may be any other number rather than limited to 24. In the embodiment of FIG. 2, a plurality of test images of each one of the color blocks are captured by the image recording device using different color temperatures (CT herein after) and an identical brightness condition. For example, in FIG. 2, the color checker 100 with a symbol (CT_1) means at least one test image of each one of the color blocks are captured using a first CT and a brightness condition, and the color checker 100 with a symbol (CT_2) means at least one test image of each one of the color blocks are captured using a second CT and a brightness condition.

The brightness condition may comprise various parameters which may affect the brightness of the test image. In one embodiment, the brightness condition comprises an aperture size of the image recording device. The aperture size is related with the light amount which the image sensor receives. In another embodiment, the brightness condition comprises an exposure time of an image sensor of the image recording device. The exposure time is also related with the light amount which the image sensor receives. In still another embodiment, the brightness condition comprises a luminance of light received by an image sensor of the image recording device.

After the test images are generated, the noise profile is computed according to the test images. The noise profile may comprise noise information for different CTs and color blocks. For example, noise A may be generated while CT_1 is used for capturing an image of the color block CB_1 by the image recording device, and noise B may be generated while CT_2 is used for capturing a test image of the color block CB_2 by the image recording device. For another example, noise C may be generated while CT_2 is used for capturing an image of the color block CB_1 by the image recording device, and noise D may be generated while CT_2 is used for capturing a test image of the color block CB_2 by the image recording device. In one embodiment, the noise profile comprises noise information for image noise in a YUV domain.

Via the above-mentioned steps, noise profiles corresponding to different CTs may be acquired. Specifically, in the embodiment of FIG. 2, a first noise profile is generated if the color checker 100 is emitted by light with a first CT (CT_1) during a noise profile generation procedure, and a second noise profile is generated if the color checker 100 is emitted by light with a second CT (CT_2) during a noise profile generation procedure These noise profiles can be stored in a storage device.

Afterwards, while another image recording device is to be calibrated, parameters of the image recording device are selectively set according to one of the noise profiles corresponding to a current color temperature. For example, if the current CT is CT_1 while calibrating the image recording device, the first noise profile corresponding to CT_1 is read and the parameters of the image recording device is set according to the first noise profile. Similarly, if the current CT is CT_2 while calibrating the image recording device, the second noise profile corresponding to the CT_2 is read and the parameters of the image recording device is set according to the second noise profile. By this way, appropriate noise profiles can be selected corresponding to the current CT, as shown in the circles with slashed lines in FIG. 2.

Oppositely, in a conventional method, a noise profile which corresponds to a fixed CT is used while calibrating the image recording device. For example, as shown in FIG. 2, if the current CT is CT_1 while calibrating the image recording device, the second noise profile corresponding to CT_2 is read and the parameters of the image recording device is set according to the second noise profile. Similarly, if the current CT is CT_3 while calibrating the image recording device, the parameters of the image recording device is still set according to the second noise profile. Accordingly, in such case, inappropriate noise profiles maybe used while calibrating the image recording device, as shown in the circles with dotted lines in FIG. 2.

In some examples, the current CT may not match any CT which is used for generating the noise profile. In such case, at least two of the stored noise profiles may be read and used for interpolating the noise profile corresponding to the current CT. As shown in FIG. 3, the current CT is CT_A (a third color temperature), which is between CT_1 and CT_2 and does not match any one of CT_1, CT_2, CT_3 which are used for generating noise profiles. Accordingly, the first noise profile correspond to CT_1 and the second noise profile corresponding to CT_2 (i.e., noise profiles corresponding to closest CTs) may be interpolated to generate a third noise profile (i.e., interpolated noise profile) corresponding to CT_A.

In one embodiment, white balances of the test images are adjusted before computing the noise profile, since the colors of test images may be affected by the color temperature. For example, if the color block has a white color, the test image thereof may become yellow if yellow light (e.g., light with a color temperature about 3000K) is used to emit the color block. In such case, if the white balance of the test image is not adjusted to recover the test image to white, wrong noise information may be acquired.

As above-mentioned, the white balance provides at least one white balance gain to adjust some color channels. However, if the white balance gain is high, the noises of the color channels which are adjusted may also be amplified. As shown in FIG. 4, different WB gains (white balance gains) are provided for the light with different CT. For example, a higher B-gain (blue light gain) and a lower R-gain (red light gain) are provided to compensate the light with a lower CT (e.g., 2300K). On the opposite, a lower B-gain and a higher R-gain are provided to compensate the light with a lower CT (e.g., 6500K). In such steps, the noise of some colors may be amplified due to the white balance gain. For example, the noise of the blue light may be greatly amplified if the white balance is performed to compensate the light with a 2300K CT, since the B-gain is high. The noise profiles generated in the embodiments of FIG. 2 and FIG. 3 may be used to reduce noises caused by the white balance gains.

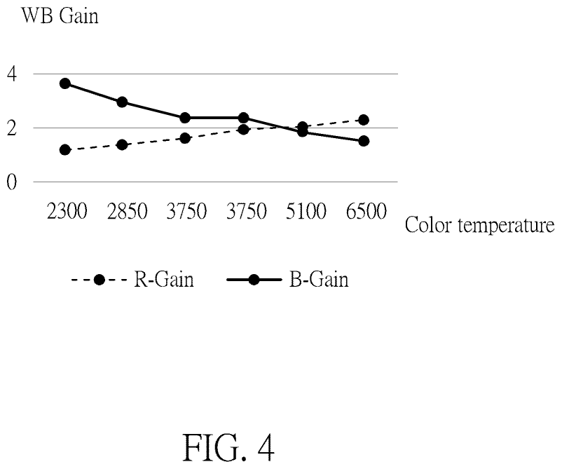

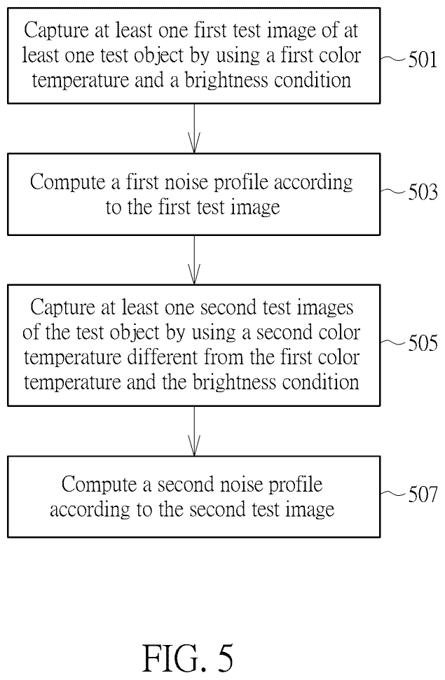

In view of above-mentioned embodiments, a noise profile generation method may be acquired, which comprises following steps shown in FIG. 5:

### Step 501

Capture at least one first test image of at least one test object (e.g., at least one color block in the color checker 100) by using a first color temperature (e.g., CT_1 in FIG. 2) and a brightness condition.

### Step 503

Compute a first noise profile according to the first test image.

### Step 505

Capture at least one second test images of the test object by using a second color temperature (e.g., CT_2 in FIG. 2) different from the first color temperature and the brightness condition.

### Step 507

Compute a second noise profile according to the second test image.

If the steps illustrated in FIG. 5 is applied to an image noise reduction method, the following step may further be comprised in the image noise reduction method:
selectively setting parameters of the image recording device according to the first noise profile or the second noise profile corresponding to a current color temperature while calibrating the image recording device (e.g., the circles marked by slashed lines in FIG. 2).

Further, as previously mentioned, since the colors of test images may be affected by the color temperature, white balances of the test images should be adjusted before computing the noise profile to avoid acquiring wrong noise information. Accordingly, in one embodiment, at least one white balance gain may be used to adjust white balances of the first test image (e.g., test images corresponding to CT_1) and the second test image before generating the first noise profile and the second noise profile. In such case, the first noise profile and the second noise profile are used for reducing noises caused by the white balance gain.

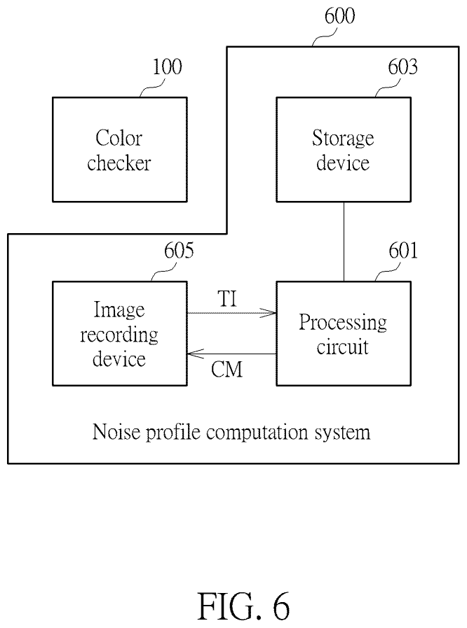

The above-mentioned methods may be applied to a noise profile generation system. FIG. 6 is a block diagram illustrating a noise profile generation system according to one embodiment of the present application. As illustrated in FIG. 6, the noise profile generation system 600 comprises a processing circuit 601, a storage device 603 and an image recording device 605. The noise profile generation system 600 may be provided in a single electronic device, and the storage device 603 may be provided inside or outside the single electronic device.

The processing circuit 601 is configured to execute at least one program stored in a storage device to perform a noise profile generation method, which comprises following steps: (a) capturing at least one first test image of at least one test object by using a first color temperature and a brightness condition; (b) computing a first noise profile according to the first test image; (c) capturing at least one second test images of the test object by using a second color temperature and the brightness condition; and (d) computing a second noise profile according to the second test image. In one embodiment, the processing circuit 601 may further perform the step of “selectively setting parameters of the image recording device according to the first noise profile or the second noise profile corresponding to a current color temperature while calibrating the image recording device”. In such case, the noise profile generation system 600 may be regarded as an image noise reduction system.

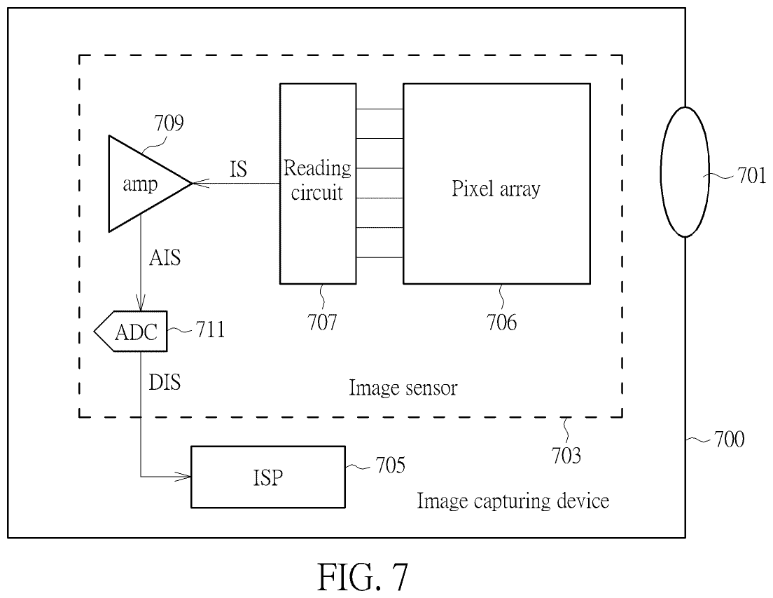

FIG. 7 is a block diagram illustrating an exemplary image recording device, which is calibrated according to the noise profile generated by the embodiments of the present application. In one embodiment, the image capturing device 700 is a camera, and may be an independent electronic device or be integrated to another electronic device such as a mobile phone or a tablet computer.

As shown in FIG. 7, the image capturing device 700 comprises a lens 701, an image sensor 703 and an ISP 705. The image sensor 703 comprises a pixel array 706, a reading circuit 707, an image signal amplifying circuit 709, and an ADC 711. The pixel array 706 comprises a plurality of pixels which generate sensing charges corresponding to the received light passing through the lens 701.

The image signal amplifying circuit 709 is configured to amplify the image signal IS to generate an amplified image signal AIS. The amplified image signal AIS is transmitted to an ADC 711 to generate a digital image signal DIS. The digital image signal DIS is transmitted to the ISP 705, which may generate images according to the digital image signal DIS (i.e., the image data). The ISP 705 may be integrated to the image sensor 703 or independent from the image sensor 703. As above-mentioned, the ISP 705 may perform noise reduction, thus the parameters thereof may be calibrated by above-mentioned embodiments, to improve the noise reduction function thereof.

In view of above-mentioned embodiments, noise profiles corresponding to different CT may be acquired, and a proper noise profile may be selected corresponding to a current CT, to improve the efficiency of noise reduction.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A noise profile generation method, for generating noise profiles of an image recording device, comprising:
(a) capturing at least one first test image of at least one test object by using a first color temperature and a brightness condition;
(b) computing a first noise profile according to the first test image;
(c) capturing at least one second test images of the test object by using a second color temperature different from the first color temperature and the brightness condition; and
(d) computing a second noise profile according to the second test image.

2. The noise profile generation method of claim 1, wherein the brightness condition comprises an aperture size of the image recording device.

3. The noise profile generation method of claim 1, wherein the brightness condition comprises an exposure time of an image sensor of the image recording device.

4. The noise profile generation method of claim 1, wherein the brightness condition comprises a luminance of light received by an image sensor of the image recording device.

5. The noise profile generation method of claim 1, wherein the test object is one of color blocks of a color checker, wherein the color blocks have different colors.

6. The noise profile generation method of claim 1, wherein the noise profile comprises noise information for image noise in a YUV domain.

7. The noise profile generation method of claim 1, further comprising:
using at least one white balance gain to adjust white balances of the first test image and the second test image before generating the first noise profile and the second noise profile;
wherein the first noise profile and the second noise profile are used for reducing noises caused by the white balance gain.

8. The noise profile generation method of claim 1, further comprising:
interpolating the first noise profile and the second noise profile to generate a third noise profile corresponding to a third color temperature different from the first and second color temperatures.

9. A noise profile generation system, comprising:
an image recording device; and
a processing circuit, configured to execute at least one program stored in a storage device to perform a noise profile generation method, which comprises following steps:
(a) capturing at least one first test image of at least one test object by using a first color temperature and a brightness condition;
(b) computing a first noise profile according to the first test image;
(c) capturing at least one second test images of the test object by using a second color temperature different from the first color temperature and the brightness condition; and
(d) computing a second noise profile according to the second test image.

10. The noise profile generation system of claim 9, wherein the brightness condition comprises an aperture size of the image recording device.

11. The noise profile generation system of claim 9, wherein the brightness condition comprises an exposure time of an image sensor of the image recording device.

12. The noise profile generation system of claim 9, wherein the brightness condition comprises a luminance of light received by an image sensor of the image recording device.

13. The noise profile generation system of claim 9, wherein the test object is one of color blocks of a color checker, wherein the color blocks have different colors.

14. The noise profile generation system of claim 9, wherein the noise profile comprises noise information for image noise in a YUV domain.

15. The noise profile generation system of claim 9, wherein the processing circuit is further configured to perform following steps:
using at least one white balance gain to adjust white balances of the first test image and the second test image before generating the first noise profile and the second noise profile;
wherein the first noise profile and the second noise profile are used for reducing noises caused by the white balance gain.

16. The noise profile generation system of claim 9, wherein the
processing circuit is further configured to perform following steps:
interpolating the first noise profile and the second noise profile to generate a third noise profile corresponding to a third color temperature different from the first and second color temperatures.

17. An image noise reduction method, for reducing image noise of images generated by the image recording device, comprising:
(a) capturing at least one first test image of at least one test object by using a first color temperature and a brightness condition;
(b) computing a first noise profile according to the first test image;
(c) capturing at least one second test images of the test object by using a second color temperature different from the first color temperature and the brightness condition; and
(d) computing a second noise profile according to the second test image; and
(e) selectively setting parameters of the image recording device according to the first noise profile or the second noise profile corresponding to a current color temperature while calibrating the image recording device.

18. The image noise reduction method of claim 17, wherein the image recording device is a camera, and the step (c) adjusts the parameters of an ISP (image signal processor) of the image recording device.

19. The image noise reduction method of claim 17, wherein the processing circuit is further configured to perform following steps:
using at least one white balance gain to adjust white balances of the first test image and the second test image before generating the first noise profile and the second noise profile;
wherein the first noise profile and the second noise profile are used for reducing noises caused by the white balance gain.

20. The image noise reduction method of claim 17, wherein the processing circuit is further configured to perform following steps:
interpolating the first noise profile and the second noise profile to generate a third noise profile corresponding to a third color temperature different from the first and second color temperatures.
